(19) United States
(12) Patent Application Publication
(10) Pub. No.: US 2014/0067471 A1
(43) Pub. Date: Mar. 6, 2014

(54) Methods, Systems and Apparatuses for Analyzing the Effectiveness of Broadcast Advertising In and On Integrated Marketing Campaigns

(71) Applicant: Deepthi Raju, Sugar Land, TX (US)

(72) Inventor: Deepthi Raju, Sugar Land, TX (US)

(73) Assignee: SmartBridge, LLC, Houston, TX (US)

(21) Appl. No.: 13/597,218

(22) Filed: Aug. 28, 2012

(51) Int. Cl. G06Q 30/02

(52) U.S. Cl. 705/7.32; 705/7.29

(57) ABSTRACT

Methods, systems, and apparatuses for correlating broadcast media advertising with its impact on the performance of all channels in the integrated marketing campaign and the overall web site relating to the offering being advertised are disclosed. A marketing performance data interface collects, over a time period, broadcast marketing performance data regarding advertisements of an offering through two or more broadcast marketing providers. The broadcast marketing performance data includes advertisement scheduling and cost information. A channel performance database stores the collected broadcast marketing performance data. A web analytics software obtains web site usage data about the impact of the advertising on a web site relating to the offering including at least one key metric. A marketing performance measurement reporting system correlates the broadcast performance marketing data with the web site usage data in near real-time, including at least one key metric, to create a time-based correlation over the time period.

### RELATED APPLICATIONS

This application relates to the following commonly assigned co-pending applications entitled:

“Methods, Systems and Apparatuses for Analyzing and Comparing Performance of Marketing Channels in Integrated Marketing Campaigns,” Ser. No. ______, filed Aug. 28, 2012, and “Methods, Systems and Apparatuses for Analyzing and Comparing Return on Investment Performance of Marketing Channels in Integrated Marketing Campaigns,” Ser. No. ______, filed Aug. 28, 2012, all of which are incorporated in their entireties by reference herein.

### TECHNICAL FIELD OF THE INVENTION

The present disclosure relates generally to systems, methods, and apparatuses for analyzing broadcast media marketing. More particularly, the disclosure relates to systems, methods and apparatuses for analyzing the effectiveness of broadcast media advertising and comparing its effect in an integrated marketing campaign, including its effect on the campaign as a whole and on different marketing channels.

### BACKGROUND

Firms, small businesses, and individuals offering goods or services—and even non-profits—often spend considerable amounts of money for advertisement and other marketing communications via broadcast media. Examples of the broadcast media venues include television, radio, newspapers, catalogs, and other mailings.

In order to determine whether their broadcast media advertising dollars are being well spent, advertisers need to be able to compare results from different advertising campaigns and when the broadcast media advertising is performed through different venues. It can also be important to compare the results of broadcast media advertising to advertising through other marketing channels. Comparing the results helps to determine if broadcast media advertising has any effect on the results of advertising through other marketing channels. Advertisers need to be able to respond quickly if a particular advertising campaign has a strong effect on their existing and potential customers. They also may desire to focus their expenditures through the marketing channels that are most effective at reaching their target audience. In order to do so, however, the advertisers must quickly obtain and analyze data reflecting their audience's response to the broadcast media advertising. Of course, it is important to respond quickly if a particular advertisement or advertising campaign has a positive effect on the target audience. But it may be even more imperative to take immediate steps if such an advertisement or campaign proves to be distasteful or otherwise unattractive to even a small segment of their target audience.

But it can be difficult to obtain and analyze such data quickly, especially from broadcast media venues. Existing methods for determining the effectiveness of broadcast media marketing communications include QR codes, vanity URLs promotion codes, and use of special telephone numbers or web sites linked with certain broadcast media marketing communications. If a potential customer goes to a company web site after watching an advertisement on television or after seeing an advertisement in a magazine, as examples, it can be difficult to determine exactly what led him or her there.

Accordingly, a need is present for methods, systems, and apparatuses to address and/or overcome issues discussed above.

### SUMMARY

The embodiments of the invention described herein include a method comprising the step of collecting, over a time period, marketing performance data from at least two providers making marketing communications for an offering through at least one venue in at least one broadcast marketing channel. The marketing communications through the at least one broadcast marketing channel include at least one broadcast marketing communication. The marketing performance data includes broadcast marketing performance data and is collected on a per provider basis in provider-specific formats. The method includes the steps of converting the marketing performance data from the provider-specific formats to a specialized format and storing the marketing performance data, in the specialized format, in a dimensional database. The method includes the steps of collecting in near real time web site usage data, on a web site relating to the offering during the time period, using web analytics software and correlating the marketing performance data with the near real time web site usage data over the time period to create at least one broadcast evaluation on at least one level of granularity, including at least one correlation relating to the broadcast marketing performance data. The method includes the step of creating a broadcast marketing performance report including the broadcast evaluation.

The embodiments of the invention described herein include an apparatus which includes a marketing performance data interface configured to upload broadcast marketing performance data over a time period. The broadcast marketing performance data relates to marketing communications for an offering made through at least one broadcast marketing provider in at least one venue of at least one broadcast marketing channel. The broadcast marketing performance data is collected on a per provider basis in a provider-specific format. The apparatus includes a marketing measurement interface coupled to the marketing performance data interface and configured to transform the broadcast marketing performance data from the provider-specific format to a specialized format of factual data and dimensional data. The apparatus includes a dimensional database coupled to the marketing measurement interface and configured to store the broadcast marketing performance data in the specialized format. The apparatus includes a web analytics software configured to obtain, on a per provider basis, web site usage data about the impact of the broadcast advertising on a web site relating to the offering. The apparatus includes a broadcast marketing performance measurement reporting system coupled to the dimensional database and to the web analytics software, the broadcast marketing performance measurement reporting system configured to correlate the broadcast marketing performance data from the dimensional database with the web site usage data to create at least one correlation on at least one level of granularity, and further configured to generate a broadcast marketing performance report including the correlation.

The embodiments of the invention described herein include an article of manufacture which includes a medium storing instructions that, if executed, enable a processor-based system to collect, over a time period, broadcast marketing performance data from at least one provider in at least one venue of at least one broadcast marketing channel used to advertise an offering. The broadcast marketing performance data includes scheduling information for broadcast advertisements. The broadcast marketing performance data is collected on a per provider basis in a spreadsheet format. The instructions, if executed, also enable the processor-based system to store the broadcast marketing performance data on a per provider basis in a marketing measurement performance interface in the spreadsheet format and convert the broadcast marketing performance data from the spreadsheet format to a specialized format of factual data and dimensional data. The instructions, if executed, also enable the processor-based system to store the broadcast marketing performance data in the specialized format in a dimensional database. The instructions, if executed, also enable the processor-based system to collect in near real time web site impact information about the impact of the broadcast advertising on a web site related to the offering, during the time period, using web analytics software. The web site impact information includes at least one key metric. The instructions, if executed, also enable the processor-based system to correlate the broadcast marketing performance data, with the near real time web site impact information to create a time-based correlation, wherein the correlation includes a comparison of the scheduling information over an interval in the time period with the key metric over the interval and to display the correlation.

The embodiments of the invention described herein include a system which includes at least one provider computer system of at least one provider configured to assemble marketing performance data regarding marketing communications for an offering, the marketing performance data being assembled in a provider-specific format, and at least one provider being from at least one marketing venue in at least one broadcast marketing channel. The system includes a marketing performance data interface coupled to the at least one provider computer system and configured to collect, over a time period, the marketing performance data, including broadcast marketing performance data, from the at least one provider computer system. The broadcast marketing performance data is collected on a per provider basis in a provider-specific format. The system includes a marketing measurement interface coupled to the marketing performance data interface and configured to transform the broadcast marketing performance data from the provider-specific format to a specialized format of factual data and dimensional data. The system includes a dimensional database coupled to the marketing measurement interface and configured to store the broadcast marketing performance data in the specialized format. The system includes a website for the offering and a web analytics system coupled to the website and configured to obtain web site usage data about the impact of the marketing communications on the web site relating to the offering. The system includes a broadcast marketing performance measurement reporting system coupled to the dimensional database and to the web analytics system, the marketing performance measurement reporting system configured to correlate the broadcast marketing performance data from the dimensional database with the web site usage data to create at least one correlation on at least one level of granularity, and further configured to generate a broadcast marketing performance report including the correlation. The system includes a display coupled to the broadcast marketing performance measurement reporting system and configured to display the broadcast marketing performance report.

Other aspects and advantages of the embodiments described herein will become apparent from the following description and the accompanying drawings, illustrating the principles of the embodiments by way of example only.

### BRIEF DESCRIPTION OF THE DRAWINGS

Features and advantages of the present invention will become apparent from the appended claims, the following detailed description of one or more example embodiments, and the corresponding figures.

FIG. 1 depicts a block diagram of a system for determining the effectiveness of broadcast media advertising of an offering in an integrated marketing campaign for the offering, in accordance with one of more embodiments of the present disclosure;

FIG. 2 depicts a process for obtaining, processing and analyzing in near real time non-broadcast marketing performance data collected in near real time, in accordance with one of more embodiments of the present disclosure;

FIG. 3a depicts a graph of two web traffic metrics over an interval of time, in accordance with one of more embodiments of the present disclosure; FIG. 3b depicts a graph of two broadcast media metrics over the interval of time of FIG. 3a, in accordance with one of more embodiments of the present disclosure;

FIG. 4 depicts a screenshot of a report prepared in accordance with one of more embodiments of the present disclosure;

FIG. 5 is a block diagram depicting a system for analyzing and comparing broadcast marketing channels (in this example, the performance of two broadcast marketing channels and three broadcast marketing providers), in accordance with one or more embodiments of the present disclosure;

FIG. 6 is a flowchart depicting a process for analyzing and comparing the performance of broadcast marketing channels (in this example, the performance of three broadcast marketing channels), in accordance with one or more embodiments of the present disclosure;

FIG. 7 depicts a screenshot of a report prepared in accordance with one of more embodiments of the present disclosure, which includes a comparison of effects of broadcast marketing and non-broadcast marketing; and

FIG. 8 depicts an architecture, in accordance with one or more embodiments of the present disclosure.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but have similar functions. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

“The internet” is a network of networks and gateways that use the TCP/IP suite of protocols. “A client” is a computer accessed by a user or viewer which issues commands to another computer called “a server.” The server performs a task associated with the client's command. “The World Wide Web” (WWW or Web) is the internet's application which displays information on the internet in a user-friendly graphical user interface format called a Web page. “A Web server” typically supports one or more clients. The Web allows users (at a client computer) who seek information on the internet to switch from server to server and database to database by viewing objects (images or text) and clicking (with a pointing device or keystroke) on corresponding highlighted words or phrases of interest (hyperlinks).

The Web can be considered as the internet with all of the resources addressed or identified as Universal Resource Locators (URLs), which displays the information corresponding to URLs, and provides a point-and-click interface to other URLs. A URL can be thought of as a Web document version of an e-mail address. Part of a URL is termed the Internet Protocol (IP) address.

An internet browser, or Web browser, is a graphical interface tool that runs internet protocols and displays results on the user's screen. The browser can act as an internet tour guide, complete with pictorial desktops, directories, and search tools used when a user “surfs the net.”

The phrase “marketing channel,” as used herein, refers to different types of methods for advertising an offering, such as a product or service. Examples of marketing channels include e-mail marketing, online advertising, social media advertising, broadcast media advertising, and search engine optimization. Examples of broadcast marketing venues include television, radio, newspapers, catalogs, magazines, mass mailings, flyers, billboards (both static and electronic) and other broadcast marketing venues).

The terms “advertising” and “advertisement(s)” are used herein to mean communications made to a target audience through paid announcements, which may be made through various marketing channels, to promote an offering. The term “marketing communication” includes advertising, but may also include other promotional aspects of marketing, such as public relations, media relations, publicity, design of packaging and of web sites for firm or an offering, design and use of marks, use of endorsements, client development and retention, and social media. While some embodiments are described with respect to advertising, other embodiments may include other types of marketing communications. The examples of various embodiments should be considered illustrative rather than limiting.

The term “conversion,” as used herein, is defined as a completion of a goal. Some examples of conversions include purchasing an offering, registering on a website, signing up for a service, or downloading a white paper.

The phrase “near real time,” as used herein, means almost in real time as events happen. This allows for updating by the provider (which may be done in near real time or on a periodic basis, depending upon the provider), transmission and processing of data, without significant delay. Real time, if taken to mean absolutely simultaneously, may be unobtainable, as even light takes time to go from one point to another.

### DETAILED DESCRIPTION

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to any particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure also describes various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

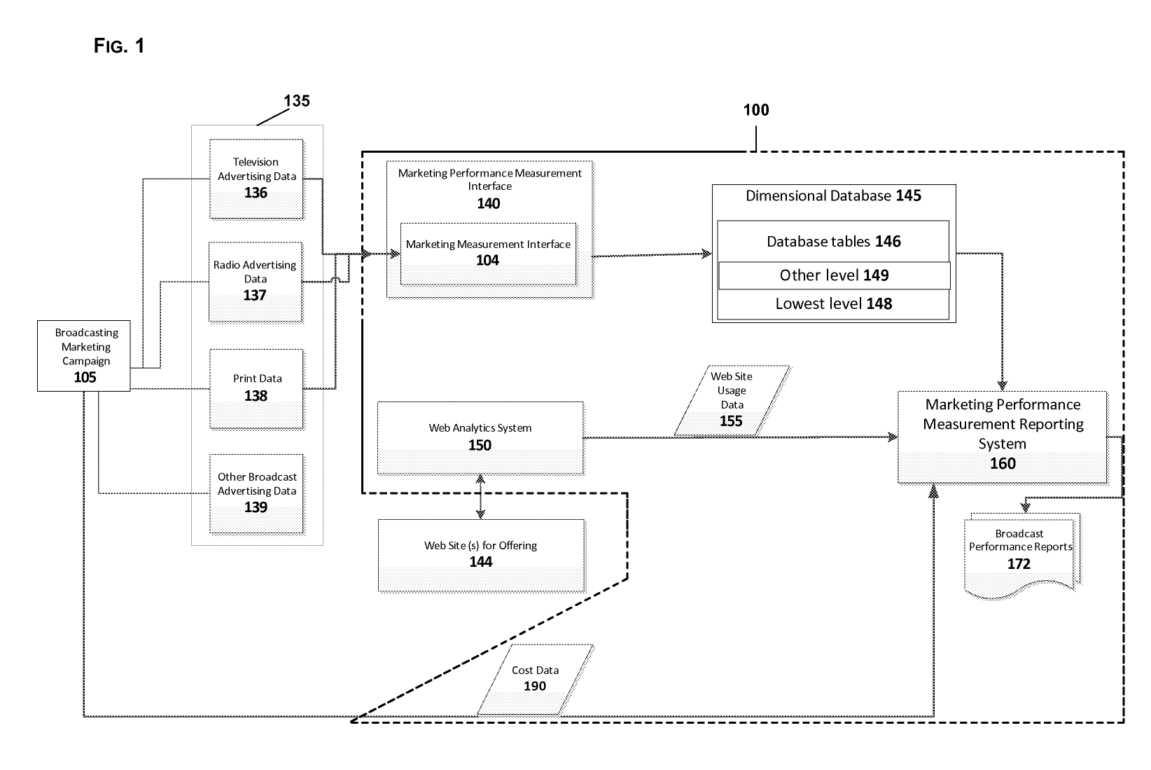

FIG. 1 depicts a block diagram of a system 100 for determining the effectiveness of broadcast media advertising of an offering in an integrated marketing campaign for the offering, in accordance with one of more embodiments of the present disclosure. FIG. 1 relates to a campaign of broadcast media advertising for an offering over a period of time. The broadcast media advertising may include advertisements and other marketing communications placed in television, radio, newspapers, magazines, catalogs, mass mailings, on billboards, and other broadcast media. In the example of the system 100 of FIG. 1, broadcast marketing performance data 135, such as television marketing performance 136, radio marketing performance data 137, print marketing performance data 138 (for example catalogs, newspapers, flyers, mass postal mailings and magazines), and other broadcast marketing performance data 139, are collected during the period of time from each provider. The broadcast marketing performance data 135 may be in any convenient provider-specific format, such as a spreadsheet (for example, an Excel® spreadsheet). The broadcast marketing performance data 135 collected includes advertisement scheduling data, which indicates when the advertising is performed over the period of time. The broadcast marketing performance data 135 may include data pertaining to the frequency and reach of the broadcast advertisements, such as gross rating point (“GRP”), net reach, costs of the advertisements, and frequency of advertisements. Net reach indicates the size of an audience exposed to the advertising. Frequency refers to how often the advertisement is running. GRP is the product of the percentage of a target audience reached by an advertisement times the frequency they see it in a given campaign (frequency×% reached). The print marketing performance data collected may include impressions (i.e. circulation) and the cost of the advertising.

The broadcast marketing performance data 135 for each provider, in its provider-specific format, is uploaded to the marketing performance measurement interface 140. The marketing performance measurement interface 140 includes a marketing measurement interface 104 which re-formats the broadcast marketing performance data 135 from the provider-specific format to a specialized format of factual data and dimensional data. The marketing performance measurement interface 140 transfers the broadcast marketing performance data in the specialized format to a dimensional database 145, which has one or more database tables 146. Each database table 146 has a lowest level 148 and one or more other levels 149. The factual data is stored on the lowest levels 148 of the database tables 146, while the dimensional data is stored on other levels 149 in the database tables 146.

When a user wants updated data, a marketing performance measurement reporting system 160 pulls the appropriate factual data and dimensional data from the database tables 146 in the dimensional database 145 as database objects and presents the data for viewing in HTML.

When a potential customer sees an ad/creative from one of the advertisement displays in a marketing channel and scans in a code, or otherwise pulls up a web page for the offering, web traffic data is tracked by a web analytics software 150. The web analytics software 150 may be any robust web analytics software such as Google® Analytics, Yahoo® Analytics, or any such analytic service. The web analytics software 150 is used to track, in near real time, all customer activity on the client's website. The web analytics software 150 may use techniques, for example embedding tracking codes. A tracking code may be embedded in a url-link, which is placed on any creative such as an email advertisement, a banner advertisement, any posts on the social media, a blog advertisement, a magazine, catalog, or newspaper. The url may also be embedded in a QR code, which may be scanned by a potential customer. Using the url link could bring the potential customer to a website relating to an offering, which would have a corresponding tracking code. The tracking codes and corresponding tracking codes contain web usage data 155 about how the visitor arrived at the website and what the visitor does at the web site. The web usage data may include one or more web usage metrics, with examples including the number of web site visits (“visits”), the number of pageviews, the number of unique pageviews, the average time on page, the number of bounces, the number of exits, the number of conversions, the number of registrations, and/or the cost per conversion. One or more of these web usage metrics may be considered a key metric. One or more of the web usage metrics (and/or key metrics) may be associated directly with a marketing channel, with a specific venue, or a provider. Other web usage metrics (and or key metrics) may not be directly associated with any specific marketing channel, venue, or provider. Referring again to FIG. 1, the output of the web analytics software 150 is a web site usage data collection (“web usage data”) 155 that is sent to the marketing performance measurement reporting system 160.

The marketing performance measurement reporting system 160 pulls factual data and dimensional data from the dimensional database 145, and also web usage data from the web analytics software 150 to create a broadcast performance report 172. The marketing performance measurement reporting system 160 may also use collected cost data 190 to create the broadcast performance report 172. The performance measurement reporting system 160 correlates the marketing performance data 130 for different marketing channels, venues or providers with the web site usage data 155 and includes one or more of the correlations in the broadcast performance report 172. The broadcast performance report 172 includes one or more broadcast marketing evaluations involving the correlations. There are several different types of broadcast marketing evaluations which may be included. A broadcast marketing evaluation may compare the performance of the two or more providers in one or more marketing channels, including a broadcast marketing channel. A broadcast marketing evaluation may compare the effectiveness of a broadcast marketing channel to one or more other broadcast marketing channels or to the effectiveness of other (non-broadcast) types of marketing channels. A broadcast marketing evaluation may compare or correlate the effectiveness of different types of advertisement or other marketing communications, over one or more marketing channels (including a broadcast marketing channel), through one or more providers. A broadcast marketing evaluation may determine whether advertising through a broadcast channel has any effect on results from other marketing channels, in aggregate or individually. For example, one might analyze whether a television advertisement aired during a social media marketing communication amplified results such as a number of web site visit generated by the social media marketing communication. The evaluation may include a comparison of web usage metrics and/or key metrics generated by marketing communications via two or more marketing channels, including the one or more broadcast marketing channel(s) or via two or more providers (or venues), in the same marketing channel or in different marketing channels.

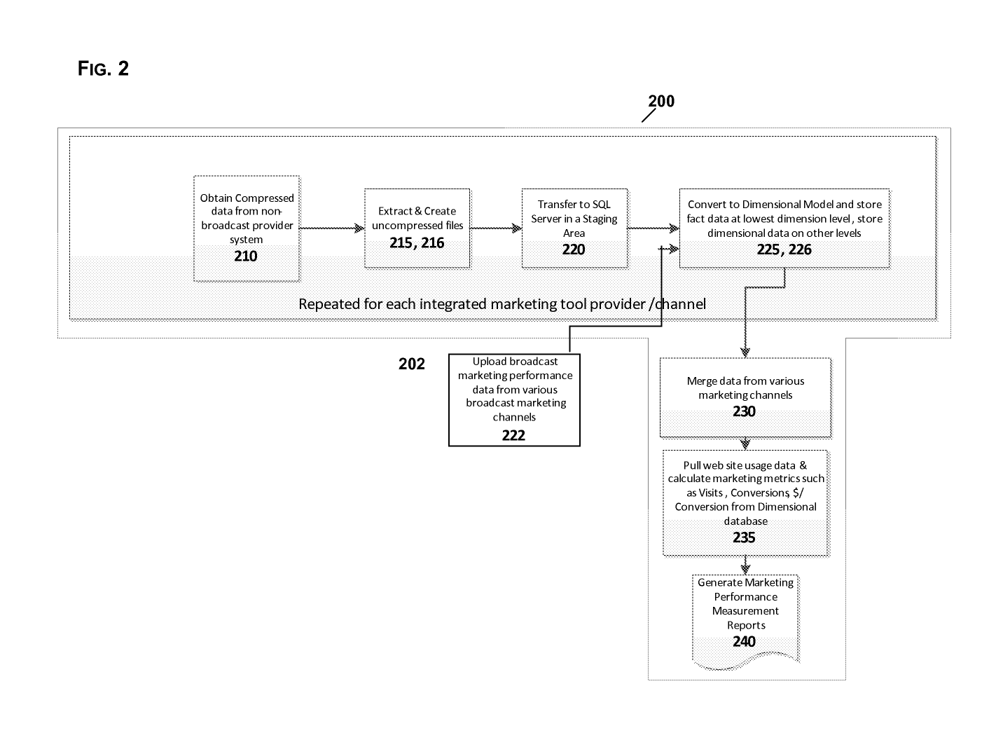

Broadcast marketing may improve (or may negatively impact) the effect of non-broadcast marketing. For example, a consumer may see an advertisement for an offering on television and then purchase the offering by going through a non-broadcast marketing channel, such as Facebook®. Non-broadcast marketing performance data and the web site usage data related to the non-broadcast marketing may be collected and correlated to the broadcast marketing performance data and the web site usage data directly related to broadcast marketing. FIG. 2 depicts a process 200 for obtaining, storing and processing non-broadcast marketing performance data collected in near real time, in accordance with one of more embodiments of the present disclosure. The marketing performance measurement interface 140 (not depicted in FIG. 2) obtains 210 a compressed data file from a system of each broadcast media provider displaying the advertisement. For the obtaining step 210, a background process within the marketing performance measurement interface 140 polls the provider systems for new data. The polling is preferably conducted continuously or at very short intervals. As the new data becomes available, the marketing performance measurement interface 140 extracts 215 the data from the compressed data file and creates 216 uncompressed data files for the data.

The uncompressed data packets for each provider are transferred 220 to a corresponding staging database, such as a SQL server database, in a staging area located in the marketing performance measurement interface 140. There is preferably one staging database for data from each provider. The uncompressed data packets are then converted 225 from a provider-specific format to the specialized format of factual data and dimensional data. Factual data are then stored 226 at a lowest dimensional level of the dimensional database. Dimensional data are stored 226 at other levels of the dimensional database. Broadcast marketing performance data is uploaded 222 in its provider-specific formats. The broadcast marketing performance data also converted 225 to the specialized format of factual data and dimensional data and stored in the dimensional database 226, with factual data being stored at the lowest dimensional level of the dimensional database and dimensional data being stored at other levels of the dimensional database.

Data from the various marketing channels, including the broadcast marketing channels, are merged 230 so that comparisons may be made and so that the effectiveness of the marketing campaign as a whole may be assessed (as well as effectiveness at other granularities of interest). Website usage data is pulled and key marketing metrics, such as number of visits, number of conversions, and/or cost per conversion, are calculated 235. A marketing performance measurement report is generated 240, which includes one or more broadcast marketing evaluations, as discussed with respect to FIG. 1, herein.

More details about the process of collecting, processing and transforming non-broadcast performance data and about collecting web usage data generated by non-broadcast marketing communications is described in the co-pending U.S. patent application Ser. No. ______, entitled “Methods, Systems and Apparatuses for Analyzing and Comparing Performance of Marketing Channels in Integrated Marketing Campaigns,” which is mentioned herein in the Related Applications section. If the broadcast performance report 172 is to include correlations of returns on investment from different marketing channels, this is disclosed in the co-pending U.S. patent application Ser. No. ______, entitled “Methods, Systems and Apparatuses for Analyzing and Comparing Return on Investment Performance of Marketing Channels in Integrated Marketing Campaigns,” which is also mentioned herein in the Related Applications section.

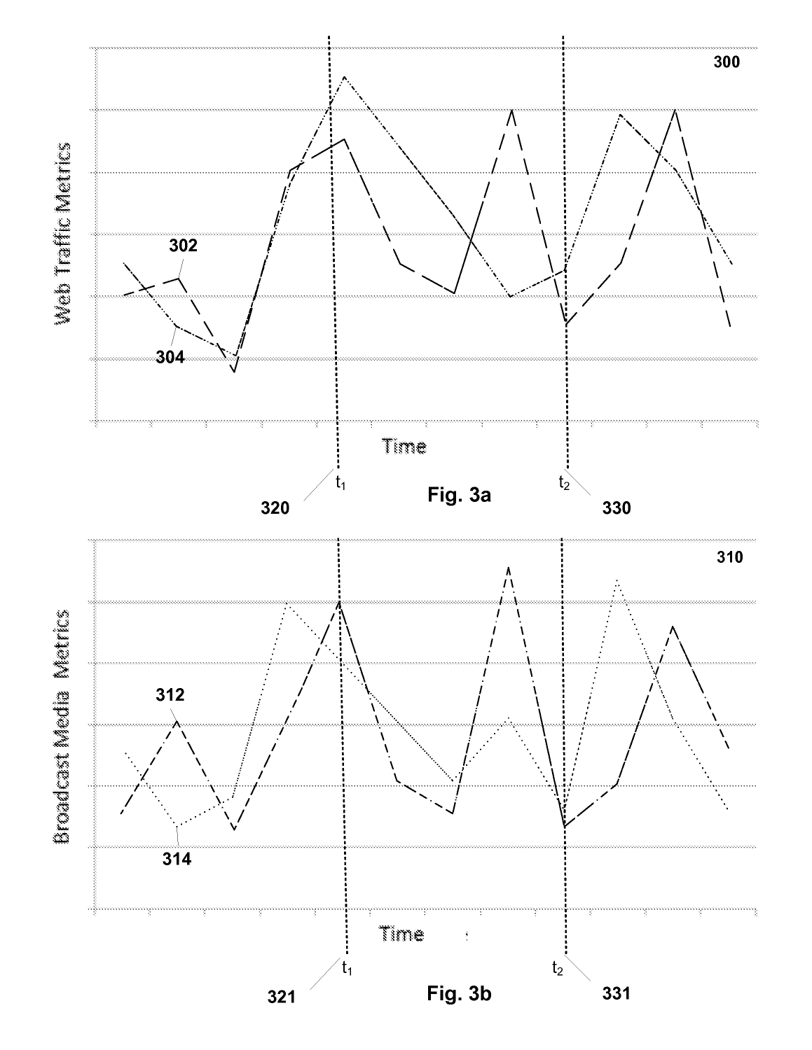

FIG. 3a depicts a graph of two web traffic metrics over a time period, in accordance with one of more embodiments of the present disclosure. FIG. 3b depicts a graph of two broadcast media metrics over the time period of FIG. 3a, in accordance with one of more embodiments of the present disclosure. The juxtaposition of FIG. 3a with FIG. 3b indicates correlation of the extent of broadcast media advertising of an offering to the effects of the broadcast media advertising on a web site associated with the offering, in accordance with one of more embodiments of the present disclosure. Such correlations may be included in the broadcast media performance report 172. Specifically, the graph 300 of FIG. 3a depicts two web traffic metrics (from web site usage data) as a first curve 302 and a second curve 304 over the time period, while the graph 310 of FIG. 3b depicts two broadcast media metrics (from broadcast marketing performance data) as a third curve 312 and a fourth curve 314 over the same time period. The web traffic metrics curves, the first curve 302 and the second curve 304 of FIG. 3a, may represent two web traffic metrics selected to be of particular interest to the customer, such as a number of visits and a number of registrations. The broadcast media metrics curves, a third curve 312 and a fourth curve 314 of FIG. 3b, may represent the two selected broadcast media metrics to be of particular interest to the customer, such as GRP and frequency. A time t₁ 320 and a time t₂ 330 on the graph 300 of FIG. 3a are the same as, respectively, a time t₁ 321 and a time t₂ 331 on the graph 310 of FIG. 3b. The times t₁ 320, 321 (from FIGS. 3a and 3b respectively) and the times t₂ 330, 331 (from FIGS. 3a and 3b respectively) have been selected to highlight a correlation between the selected broadcast media metrics and the selected web traffic metrics. In this particular example, as the broadcast media metrics represented by the third curve 312 and the fourth curve 314 increase to high levels (at, for example, the time t₁ 321) as depicted in FIG. 3b, the web traffic metrics represented by the first curve 302 and the second curve 304 also increase (at the time t₁ 320), as depicted in FIG. 3a. As the broadcast media metrics represented by the third curve 312 and the fourth curve 314 decrease to low levels (at, for example, the time t₂ 331) as depicted in FIG. 3b, the web traffic metrics represented by the first curve 302 and the second curve 304 as depicted in FIG. 3a also decrease to low levels (at the time t₂ 330). The positive correlation of the example of FIG. 3a and FIG. 3b would be indicative of a successful broadcast media advertising campaign. With an unsuccessful broadcast media advertising campaign, there might be little or no correlation between the broadcast media metrics (represented by the third curve 312 and the fourth curve 314 of FIG. 3b) and the web traffic metrics (represented by the first curve 302 and the second curve 304 as depicted in FIG. 3a).

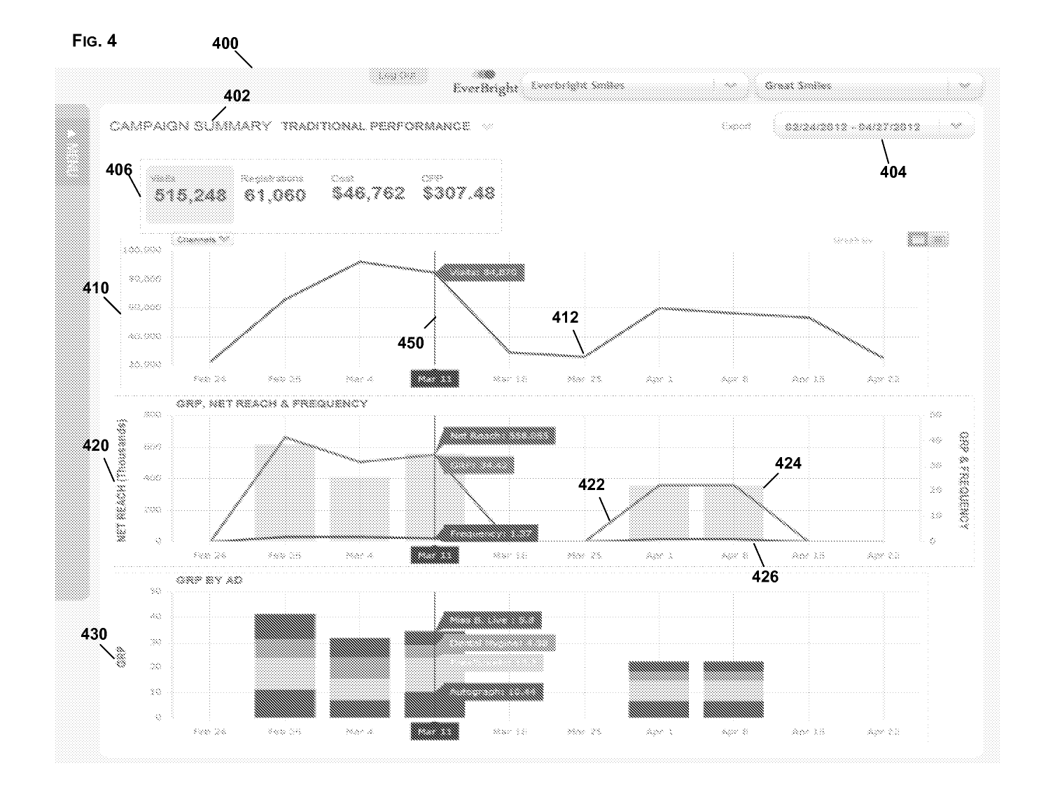

FIG. 4 depicts a screenshot 400 of a broadcast media performance report 140 prepared in accordance with one of more embodiments of the present disclosure. A title 402 (Campaign Summary[:] Traditional Performance] is located near the upper left of the screenshot 400. A time period 404 is indicated near the upper right of the screenshot 400. Four web site usage metrics 406, which include number of visits, number of registrations, cost, and cost per rating point (“CPP”), are listed below the title. There are three graphs 410, 420, 430 over the time period 404 depicted on the screenshot 400. The top graph 410 depicts a web site usage metric, in this case number of visits 412, over the time period 404. The middle graph 420 depicts three broadcast media metrics (GRP 422, net reach 424, and frequency 426) over the time period 404. The lower graph 430 depicts GRP by four particular advertisements over the time period 404. A vertical line 450 connecting the three graphs 410, 420, 430 pulls up the values of the graphed metrics for a particular date selected for a comparison, in this case March 11. On March 11, in the example of screenshot 400, the number of visits was 84,870, the net reach of the broadcast media advertisements 558,055, the GRP of the broadcast media advertisements was 34.42, and the frequency was 1.37. Also on March 11, the vertical line 450 indicates that the GRP of a Miss B. Live advertisement was 5.8, the GRP of a Dental Hygine [sic] advertisement was 4.98, the GRP of a Free Tickets advertisement was 13.23, and the GRP of an Autograph advertisement was 10.44.

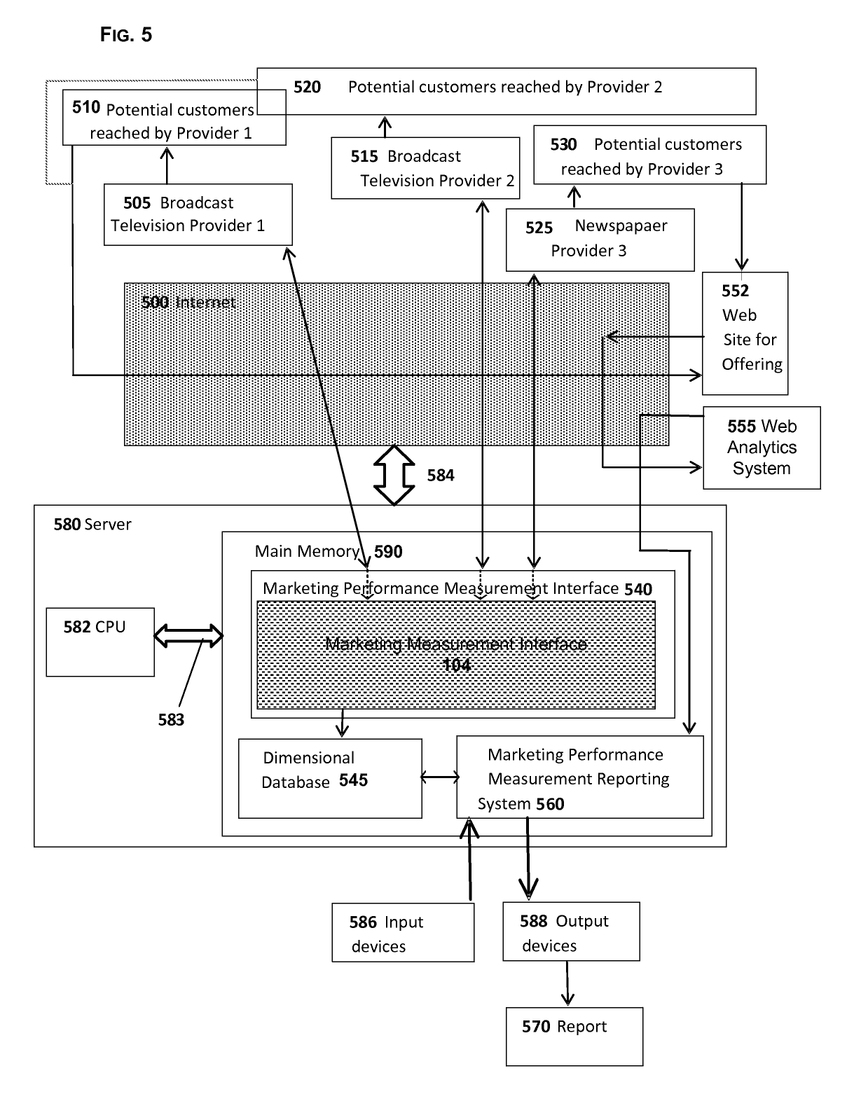

FIG. 5 is a block diagram depicting a system for analyzing and comparing broadcast marketing channels, in accordance with one or more embodiments of the present disclosure. In the example of FIG. 5, the performance of two broadcast marketing channels and three providers are compared. Two of the providers shown in FIG. 5 are television advertising providers 505, 515 and one is a newspaper advertising provider 525. A television advertising provider 1 505 of a television marketing channel 1, displays advertisements for an offering. Potential customers 510 reached by provider 1 505 may respond by going to (or if the television advertising is displayed on a computer, by clicking through to) a website 552 for the offering, via the internet 500. (Some of the potential customers 510 reached by provider 1 505 may respond in different ways or not at all.) A provider 2 515 of the marketing channel 1 displays advertisements for the offering. Potential customers 520 reached by provider 2 515 may respond by going to (or clicking through to) the website 552 for the offering, via the internet 500. (Some of the potential customers 510 reached by provider 2 515 may respond in different ways or not at all.) In some cases, the potential customers reached by one provider by overlap with the potential customers reached by another provider. In FIG. 5, the potential customers 520 reached by provider 2 515 have a degree of overlap with the potential customers 510 reached by provider 1 505. A provider 3 525 of marketing channel 2 displays advertisements for the offering. Potential customers 530 reached by provider 3 525 may respond by going to (or clicking through to) the website 552 for the offering, via the internet 500. (Some of the potential customers 530 reached by provider 3 525 may respond in different ways or not at all.)

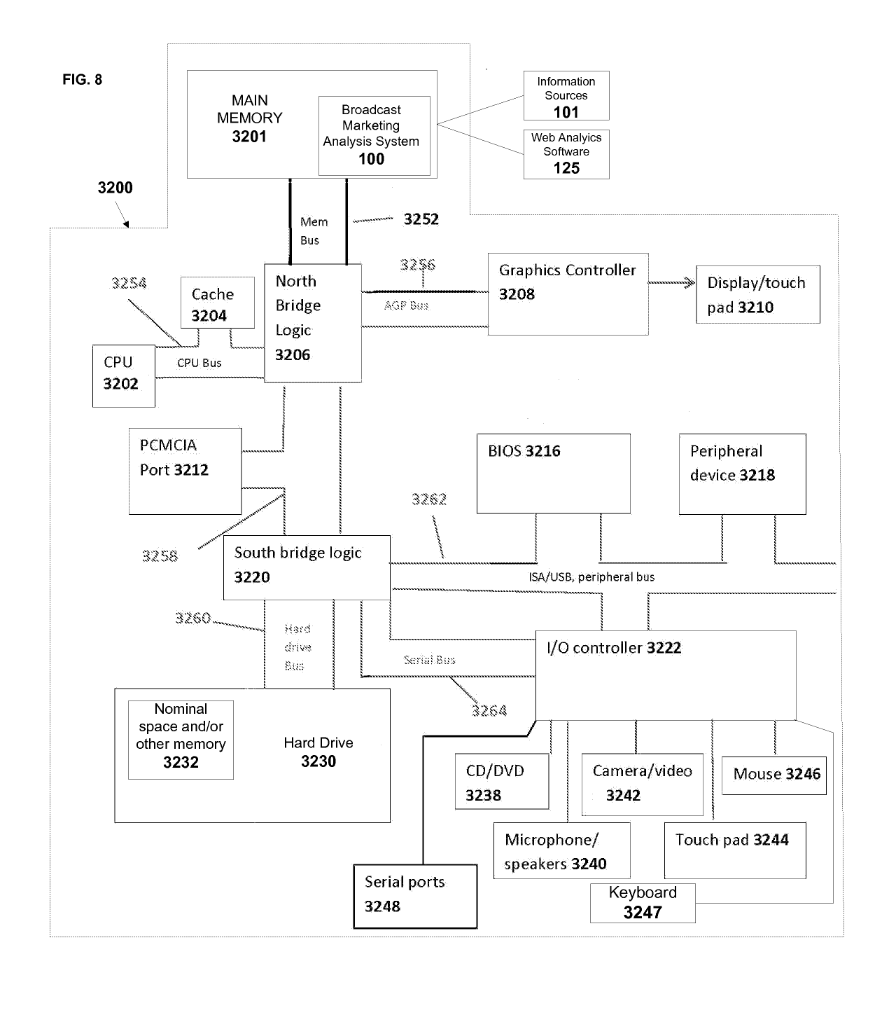

Continuing to refer to FIG. 5, a server 580 communicates over the internet 500 through an internet connection 584. (The server 500 of FIG. 5 is a simplified version; more detail of some components of a typical server in accordance with one or more embodiments of the present disclosure is provided in FIG. 8.) The internet connection 584 may be of any convenient kind, and may operate, for example, via hard wire or wirelessly. The server 580 has a central processing unit (“CPU”) 582 which may communicate through a bus 583 with a main memory 590. One or more input devices 586 and one or more output devices 588 allow user interaction with the server 580. Alternatively, the input devices 586 and/or the output devices 588 may be part of one or more client computer systems (not depicted in FIG. 5), in communication with the server 500.

Referring again to FIG. 5, the main memory 590 includes a marketing performance measurement interface 540. Marketing performance data from the provider 1 505, the provider 2 515, and the provider 3 525 are uploaded to the marketing performance measurement interface 540, in provider-specific formats, preferably in a spreadsheet format. A marketing performance interface 104 re-formats the broadcast marketing performance data from the provider-specific format to a specialized format of factual data and dimensional data, which is sent to a dimensional database 545.

Referring again to FIG. 5, a web analytics system 540 collects web usage information from the web site 552 and sends the web usage information to a marketing performance measurement reporting system 560. The web usage information may comprise web usage that can be directly linked to the broadcast marketing conducted by the broadcast marketing channels or may also include web usage that is not directly linked to the broadcast marketing conducted by the broadcast marketing channels. The marketing performance measurement reporting system 560 pulls the factual data and the dimensional data from the dimensional database 545. The marketing performance measurement reporting system 560 correlates the factual data and the dimensional data with the web usage information and uses the correlations to create reports 570, which may be displayed on (or printed by) one or more of the output devices 588.

In other embodiments, non-broadcast marketing channels are also used for marketing of the offering, with non-broadcast marketing performance data collected and processed as described in reference to FIG. 2 herein and in the co-pending U.S. patent application Ser. No. ______, entitled “Methods, Systems and Apparatuses for Analyzing and Comparing Performance of Marketing Channels in Integrated Marketing Campaigns,” previously mentioned herein. In the other embodiments, web usage data generated by non-broadcast marketing communications (or any source) may be collected as described with respect to FIG. 5 herein and as further described in the co-pending U.S. patent application Ser. No. ______, entitled “Methods, Systems and Apparatuses for Analyzing and Comparing Performance of Marketing Channels in Integrated Marketing Campaigns.”

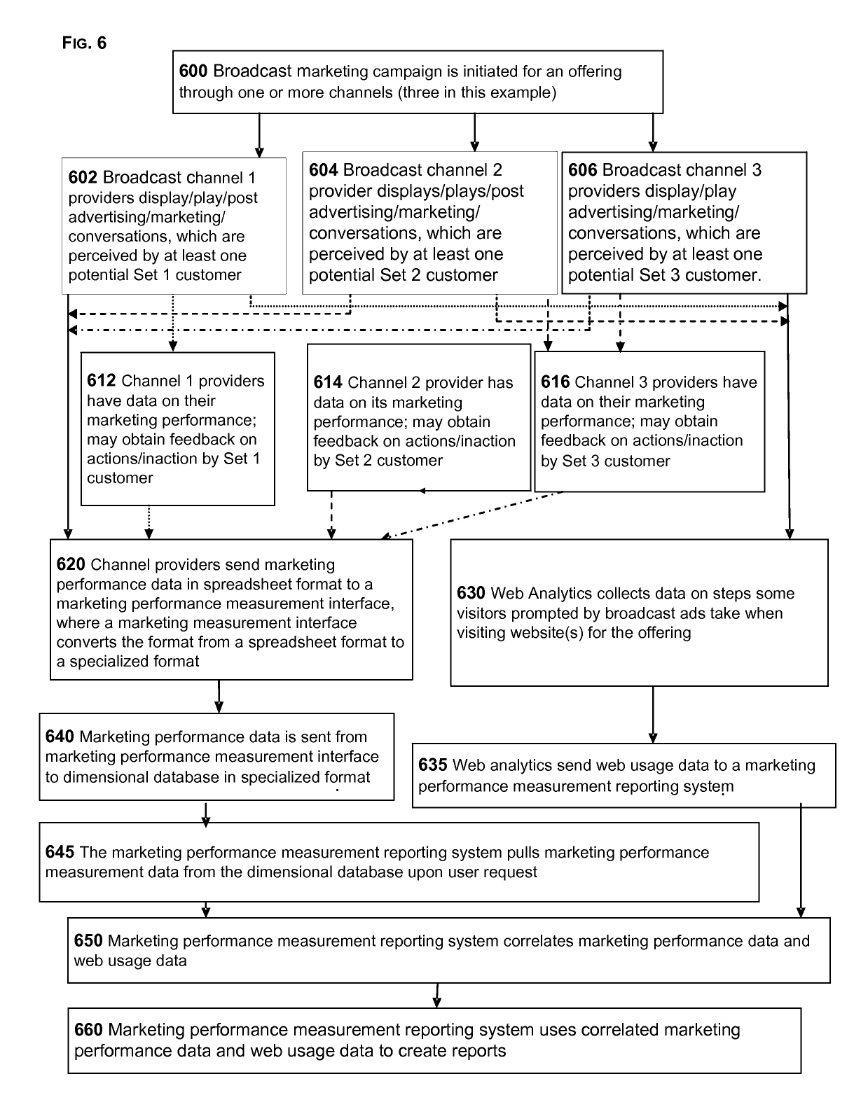

FIG. 6 is a flowchart depicting a process for analyzing and comparing the performance of broadcast marketing channels, in accordance with one or more embodiments of the present disclosure. In the example of FIG. 6, the performance of three broadcast marketing channels are analyzed and compared. A marketing campaign is initiated for an offering through three channels. In the example of FIG. 6, two or more providers of broadcast marketing Channel 1 display/play/post 602 advertising/marketing/conversations, which are perceived by at least one potential Set 1 customer. A single provider of broadcast marketing Channel 2 displays/plays/posts 604 advertising/marketing/conversations, which are perceived by at least one potential Set 2 customer. Two or more providers of broadcast marketing Channel 3 display/play 606 advertising/marketing/conversations, which are perceived by at least one potential Set 3 customer.

The broadcast advertising providers of Channel 1 have 612 data on their marketing performances and may obtain feedback on actions/inaction by Set 1 customers, the data and feedback comprising marketing performance data for the providers of Channel 1. The broadcast advertising provider of Channel 2 has 614 data on its marketing performance and may obtain feedback on actions/inaction by Set 2 customers, the data and feedback comprising marketing performance data for the provider of Channel 2. The Channel 3 broadcast advertising providers have 616 data on their marketing performances and may obtain feedback on actions/inaction by Set 3 customers, the data and feedback comprising marketing performance data for the providers of Channel 3.

Continuing to refer to FIG. 6, the providers send 620 their respective broadcast marketing performance data in compressed packets in provider specific formats to a marketing performance measurement interface, responsive to polling by the marketing performance measurement interface. The marketing performance measurement interface extracts the data in the compressed packets and stores it in staging databases, one for each provider.

For customers visiting offering web site, web analytics system collects 630 data on steps taken by visitor during visit, the determinations and the step data comprising web usage data. The marketing performance measurement reporting system pulls 635 the web usage data from the web analytics system. The marketing performance measurement reporting system pulls 645 the marketing performance measurement data in the form of factual data and dimensional data from the dimensional database upon user request. Marketing performance measurement reporting system correlates 650 the marketing performance data and the web usage data. Marketing performance measurement reporting system uses 660 the correlated marketing performance data and web usage data to create a broadcast performance report. As discussed with respect to FIG. 1, the broadcast performance report includes one or more broadcast marketing evaluations.

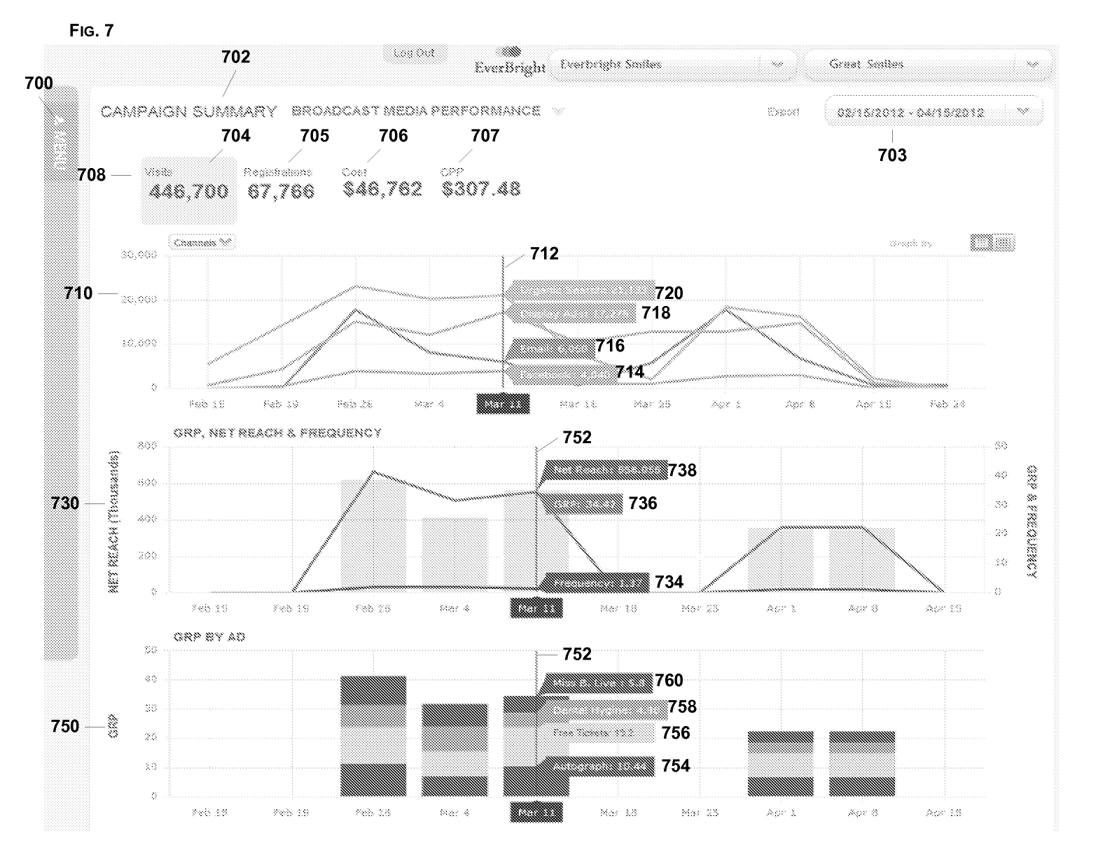

FIG. 7 depicts a screenshot 700 of a broadcast media performance report 140 prepared in accordance with one of more embodiments of the present disclosure, which includes a comparison of effects of broadcast marketing and non-broadcast marketing. A title 702 (Campaign Summary[:] Broadcast Media Performance] is located near the upper left of the screenshot 700. A time period 703 is indicated near the upper right of the screenshot 700. Four web site usage metrics 708, which include a number of web site visits generated (“number of visits”) 704, a number of registrations 705, cost of the marketing 706 and cost per rating point (“CPP”) 707, are listed below the title 702. The number of visits 704 is highlighted. There are three graphs 710, 730, 750 over the time period 703 depicted on the screenshot 700. The top graph 710 depicts the highlighted web site usage metric, in this case number of visits 704, over the time period 703, broken down by marketing channel. The top graph 710 includes four curves indicating the number of website visits from four marketing channels: Facebook 714, E-mail 716, Display Ads 718 and Organic Search 720. The Display Ads 718 comprises a broadcast marketing channel, while Facebook 714, Email 716 and Organic Searches 720 are non-broadcast marketing channels. A first vertical date line 712 allows one to view the number of visits from each marketing channel (Facebook 714, E-mail 716, Display Ads 718 and Organic Search 720) on that date, in this case March 11. If one of the other web site usage metrics 708 were highlighted (the number of registrations 705, the cost of the marketing 706 or the cost per rating point (“CPP”) 707), one would be able to view a similar breakdown by marketing channel for the highlighted metric over the relevant time period 703.

Continuing to refer to FIG. 7, the middle graph 730 depicts three broadcast media measurements of scope of marketing, GRP 736, net reach 738, and frequency 734 of the broadcast marketing, over the time period 703. This indicates how extensive the broadcast marketing was over the time period 703. A second vertical date line 732 allows one to view numerical values for the GRP 736, the net reach 738, and the frequency 734 of the broadcast marketing for the date, in this case March 11. Comparing the middle graph 730 to the top graph 710 allows one to determine whether higher levels of broadcast marketing (as depicted on the middle graph 730) had an effect on visits linked to any of the marketing channels (As depicted on top graph 710). In the example of FIG. 7, higher levels of broadcast marketing on March 11 may have had an effect on visits via Facebook 714, Display Ads 718, and Organic Search 720, even though Facebook 714 and Organic Search 720 are not directly related to the broadcast marketing. The number of visits generated through e-mail 716 does not increase on March 11, but does seem to spike on April 1, which reflects another date with an increased level of broadcast marketing, as indicated by the middle graph 730.

The lower graph 750 depicts the GRP of the broadcast market communications by four particular marketing communications represented by stacked bar graphs: Autograph 754, Free Tickets 756, Dental Hygine [sic.] 758 and Miss B Live 760, over the time period 703. A third vertical line 752 connecting the four particular marketing communications pulls up the GRP values of each of the four marketing communications (Autograph 754, Free Tickets 756, Dental Hygine [sic.] 758 and Miss B Live 760) for a particular date selected for a comparison, in this case March 11. Comparing the lower graph 750 with the top graph 710 and middle graph 730 may indicate which of the four marketing communications was more effective in generating a number of visits.

On March 11, in the example of screenshot 700, the number of visits was 4040 from Facebook 714, 6050 via E-mail 716, 17,276 via Display Ads 718 and 21,133 via Organic Search 720. The net reach 738 of the broadcast media advertisements 558,055, the GRP 736 of the broadcast media advertisements was 34.42, and the frequency 734 was 1.37. Also on March 11, the vertical line 752 indicates that the GRP of a Miss B. Live 760 marketing communication was 5.8, the GRP of a Dental Hygine [sic.] 758 marketing communication was 4.98, the GRP of a Free Tickets 756 marketing communication was 13.23, and the GRP of an Autograph 754 marketing communication was 10.44.

Turning now to FIG. 8, a depicted architecture includes a machine 3200 with a main memory 3201 storing a broadcast marketing analysis system 100, in accordance with one or more embodiments of the present disclosure. The machine 3200 may be configured in any number of ways, including as a laptop unit, a desktop unit, a network server, mobile device, telephone, net-book, or any other configuration. The machine 3200 generally includes a central processing unit (CPU) 3202 coupled to the main memory 3201 and to a variety of other peripheral computer system components through an integrated bridge logic device 3206. The bridge logic device 3206 is sometimes referred to as a “North bridge” for no other reason than it often is depicted at the upper end of a computer system drawing. The CPU 3202 couples to the North bridge logic 3206 via a CPU bus 3254, or the bridge logic 3206 may be integrated into the CPU 3202. The CPU 3202 may comprise, for example, of an i5 Core microprocessor. It should be understood, however, that the machine 3200 could include other alternative types of microprocessors. Further, an embodiment of the machine 3200 may include a multiple-CPU architecture, with each processor coupled to the bridge logic unit 3206. An external cache memory unit 3204 may further couple to the CPU bus 3254 or directly to the CPU 3202.

Continuing to refer to FIG. 8, the main memory 3201 couples to the bridge logic unit 3206 through a memory bus 3252. The main memory 3201 functions as the working memory for the CPU 3202 and generally includes a conventional memory device or array of memory devices in which program instructions and data are stored. The main memory 3201 may comprise any suitable type of memory such as dynamic random access memory (DRAM), or any of the other various types of DRAM devices, such as synchronous DRAM (SDRAM), extended data output DRAM (EDO DRAM), or Rambus™ DRAM (RDRAM). The North bridge 3206 couples the CPU 3202 and main memory 3201 to the peripheral devices in the system through a Peripheral Component Interconnect (PCI) bus 3258 or other expansion bus, such as an Extended Industry Standard Architecture (EISA) bus. The present disclosure, however, is not limited to any particular type of expansion bus, and thus various buses may be used, including a high speed (66 MHz or faster) PCI bus. Various peripheral devices that implement the PCI protocol may reside on the PCI bus 3258 as well.

Referring again to FIG. 8, the broadcast marketing analysis system 100 stored in the main memory 3201 preferably includes components depicted in FIG. 1 and functions as in the description herein of that figure. One or more broadcast marketing data information sources 101 and a web analytics software 150 may be external to the machine 3200, but would be able to communicate with the broadcast marketing analysis system 100.

The machine 3200 includes a graphics controller 3208 that couples to the bridge logic 3206 via an expansion bus 3256. As shown in FIG. 5, the expansion bus 3256 comprises an Advanced Graphics Port (AGP) bus. Alternatively, the graphics controller 3208 may couple to bridge logic 3206 through the PCI bus 3258. The graphics controller 3208 may embody a typical graphics accelerator generally known in the art to render three-dimensional data structures on display 3210. Bridge logic 3206 includes a PCI interface to permit master cycles to be transmitted and received by bridge logic 3206. The bridge logic 3206 also includes an interface for initiating and receiving cycles to and from components on the AGP bus 3256. The display 3210 comprises any suitable electronic display device upon which an image or text can be represented. A suitable display device may include, for example, a cathode ray tube (CRT), a liquid crystal display (LCD), a thin film transistor (TFT), a virtual retinal display (VRD), a touch pad, or any other type of suitable display device.

The machine 3200 may comprise a computer system and may also optionally include a Personal Computer Memory Card International Association (PCMCIA) drive 3212 coupled to the PCI bus 3258. The PCMCIA drive 3212 is accessible from the outside of the machine and accepts one or more expansion cards that are housed in special PCMCIA cards, enclosures which are approximately the size of credit cards but slightly thicker. Accordingly, PCMCIA ports are particularly useful in laptop computer systems, in which space is at a premium. A PCMCIA card typically includes one connector that attaches to the PCMCIA port 3212, and additional connectors may be included for attaching cables or other devices to the card outside of the machine 3200. Accordingly, various types of PCMCIA cards are available, including modem cards, network interface cards, bus controller cards, and memory expansion cards.

If other secondary expansion buses are provided in the computer system, another bridge logic device 3220 typically couples the PCI bus 3258 to that expansion bus. This bridge logic is sometimes referred to as a “South bridge,” reflecting its location vis-a-vis the North bridge in a typical computer system drawing.

In FIG. 8, the South bridge 3220 couples the PCI bus 3258 to an Industry Standard Architecture (ISA) bus 3262 and to a hard drive bus 3260. The hard drive bus 3260 typically interfaces input and output devices, such as a CD ROM drive and/or Digital Video Disc (DVD) drive 3238, a hard disk drive 3230, microphone and/or speaker divers 3240, camera and/or video drivers 3242, a touch pad driver 3244, and/or a mouse driver 3246, in accordance with the embodiment of the disclosure shown in FIG. 5. The hard drive bus 3260 shown in FIG. 5 couples to the hard drive 3230, which has nominal space 3232 and may have other memory.

Also in FIG. 8, various ISA-compatible devices are depicted as coupled to the ISA bus 3262, including a BIOS ROM 3216. The BIOS ROM 3216 typically is a “nonvolatile” memory device, which means that the memory contents remain intact even when the machine 3200 powers down. By contrast, the contents of the main memory 3201 typically are “volatile” and thus are lost when the computer shuts down.

The South bridge 3220 of FIG. 8 supports an input/output controller 3222 that operatively couples to basic input/output devices such as a keyboard 3247, a mouse 3246, a CD/DVD drive 3238, general purpose parallel and serial ports 3248, and various input switches such as a power switch and a sleep switch (not shown). The I/O controller 3222 typically couples to the South bridge via a standard bus, shown as the ISA bus 3262 in FIG. 5. A serial bus 3264 may provide an additional connection between the I/O controller 3222 and South bridge 3220. The I/O controller 3222 typically includes an ISA bus interface (not specifically shown) to transmit and receive registers (not specifically shown) for exchanging data with the South bridge 3220 over the serial bus 3264.

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

The drawing figures are not necessarily to scale and certain features may be shown exaggerated in scale or in somewhat generalized or schematic form in the interest of clarity and conciseness. In the description which follows like parts may be marked throughout the specification and drawing with the same reference numerals. The foregoing description of the figures is provided for a more complete understanding of the drawings. It should be understood, however, that the embodiments are not limited to the precise arrangements and configurations shown. Although the design and use of various embodiments are discussed in detail below, it should be appreciated that the present invention provides many inventive concepts that may be embodied in a wide variety of contexts. The specific aspects and embodiments discussed herein are merely illustrative ways to make and use the invention, and do not limit the scope of the invention. It would be impossible or impractical to include all of the possible embodiments and contexts of the invention in this disclosure. Upon reading this disclosure, many alternative embodiments of the present invention will be apparent to persons of ordinary skill in the art.

This disclosure also described various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A method, comprising:
collecting, over a time period, marketing performance data from at least two providers making marketing communications for an offering through at least one venue in at least one broadcast marketing channel, wherein the marketing communications through the at least one broadcast marketing channel comprises at least one broadcast marketing communication, the marketing performance data including broadcast marketing performance data, wherein the marketing performance data is collected on a per provider basis in provider-specific formats;
converting the marketing performance data from the provider-specific formats to a specialized format and storing the marketing performance data, in the specialized format, in a dimensional database;
collecting in near real time web site usage data, on a web site relating to the offering during the time period, using web analytics software;
correlating the marketing performance data with the near real time web site usage data over the time period to create at least one broadcast evaluation on at least one level of granularity, including at least one correlation relating to the broadcast marketing performance data; and
creating a broadcast marketing performance report including the broadcast evaluation.

2. The method of claim 1, further comprising displaying the broadcast marketing performance report.

3. The method of claim 1, wherein the provider-specific formats of the broadcast marketing performance data include a spreadsheet format.

4. The method of claim 1, wherein the specialized format is a format of factual data and dimensional data and wherein the factual data in the specialized format is stored at a lowest dimensional level of the dimensional database.

5. The method of claim 1, wherein the conversion of the broadcast marketing performance data from a provider-specific format to a specialized format is performed by a measurement management interface.

6. The method of claim 1, wherein the web site usage data includes at least one web usage metric.

7. The method of claim 6, wherein the at least one web usage metric includes a key metric used in the at least one correlation.

8. The method of claim 7, wherein the key metric used in the at least one correlation comprises the number of conversions made at the web site over a time interval of interest and the correlation is made on at least a marketing channel level of granularity.

9. The method of claim 7, wherein the key metric used in the at least one correlation is a number of visits made to the web site, a number of registrations made, a number of conversions, or a cost of conversion.

10. The method of claim 6, wherein the at least one web usage metric includes a number of web site visits generated, a number of pageviews generated, a number of unique pageviews generated, a number of conversions generated, or a cost per conversion generated.

11. The method of claim 1, wherein the at least one level of granularity is an overall marketing campaign level of granularity, a marketing channel level of granularity, a venue level of granularity or a provider level of granularity.

12. The method of claim 1, wherein the web site usage data includes a number of pageviews generated, a number of unique pageviews generated, an average time on page, a number of bounces generated, a number of exits generated, a number of conversions generated, or a cost per conversion.

13. The method of claim 1, wherein there are at least two marketing channels, including at least one non-broadcast marketing channel and the marketing performance data includes non-broadcast marketing performance data and further comprising:
polling for and collecting in near real time the non-broadcast marketing performance data as a compressed data packet on a per provider basis in provider-specific formats;
extracting the non-broadcast marketing performance data from the compressed data packet and creating an un-compressed packet of the non-broadcast marketing performance data;
storing the un-compressed packet of non-broadcast marketing performance data in a staging database of a staging area; and
transforming the un-compressed packet of non-broadcast marketing performance data from the provider-specific format to a specialized format of factual data and dimensional data and storing the non-broadcast marketing performance data in the specialized format in the dimensional database.

14. The method of claim 13, wherein the uncompressed packets of the non-broadcast marketing performance data from different providers are stored in separate staging databases.

15. The method of claim 13, wherein the at least one broadcast marketing evaluation includes a correlation of the impact of the broadcast marketing performance on the non-broadcast marketing performance.

16. The method of claim 13, wherein the marketing communications for the offering made through the at least one venue in the at least one broadcast marketing channel is part of an integrated marketing campaign and the broadcast marketing evaluation includes a correlation of the effects of the broadcast marketing performance on the overall performance of the integrated marketing campaign.

17. The method of claim 1, wherein the broadcast marketing performance data includes a gross rating point (“GRP”) of a broadcast that includes the broadcast marketing communication, a net reach of the broadcast that includes the broadcast marketing communication, cost information for the broadcast marketing communication, a frequency of the broadcast marketing communication.

18. The method of claim 1, wherein the venue of the broadcast marketing channel includes a print venue, a television venue or a radio venue.

19. An apparatus, comprising:
a marketing performance data interface configured to upload broadcast marketing performance data over a time period, the broadcast marketing performance data relating to marketing communications for an offering made through at least one broadcast by at least one broadcast marketing provider in at least one venue of at least one broadcast marketing channel, the broadcast marketing performance data collected on a per provider basis in a provider-specific format;
a marketing measurement interface coupled to the marketing performance data interface and configured to transform the broadcast marketing performance data from the provider-specific format to a specialized format of factual data and dimensional data;
a dimensional database coupled to the marketing measurement interface and configured to store the broadcast marketing performance data in the specialized format;
a web analytics software configured to obtain, on a per provider basis, web site usage data about the impact of the broadcast advertising on a web site relating to the offering; and
a broadcast marketing performance measurement reporting system coupled to the dimensional database and to the web analytics software, the marketing performance measurement reporting system configured to correlate the broadcast marketing performance data from the dimensional database with the web site usage data to create at least one correlation on at least one level of granularity, and further configured to generate a broadcast marketing performance report including the correlation.

20. The apparatus of claim 19, wherein the correlation is a time-based correlation over a time interval of interest.

21. The apparatus of claim 19, wherein the web site usage data includes at least one web usage metric.

22. The apparatus of claim 21, wherein at least one web usage metric is used in the correlation, the one web usage metric being a number of web site visits generated, a number of pageviews generated, a number of unique pageviews generated, a number of conversions generated, a cost per conversion generated, a number of visits made to the web site, a number of registrations made, or a number of conversions.

23. The apparatus of claim 19, wherein the at least one level of granularity is an overall marketing campaign level of granularity, a marketing channel level of granularity, a venue level of granularity or a provider level of granularity.

24. The apparatus of claim 19, wherein the broadcast marketing performance data is a gross rating point (“GRP”) of the broadcast, a net reach of the broadcast, a cost information for the marketing communication in the broadcast, or a frequency of the marketing communication in the broadcast.

25. The apparatus of claim 19, wherein the venue includes a print venue and the broadcast marketing performance data includes circulation of print media used for the marketing communication in the print venue.

26. The apparatus of claim 19, wherein there are at least two marketing channels, including at least one non-broadcast marketing channel and the marketing performance data includes non-broadcast marketing performance data relating to non-broadcast marketing communications for the offering made through the at least one non-broadcast marketing channel, wherein the marketing measurement performance interface is further configured to poll for and collect in near real time the non-broadcast marketing performance data as a compressed data packet on a per provider basis in provider-specific formats, extract the non-broadcast marketing performance data from the compressed data packet and create an un-compressed packet of the non-broadcast marketing performance data, further comprising:
a staging area in the marketing measurement performance interface having one or more staging databases for storing the un-compressed packet of non-broadcast marketing performance data, and wherein the marketing measurement performance interface is further configured to convert the un-compressed packet of non-broadcast marketing performance data stored in the staging area to the specialized format of factual data and dimensional data and to send the non-broadcast marketing performance data in the specialized format to the dimensional database for storage.

27. The apparatus of claim 26, wherein the at least one correlation includes an effect of the performance of the marketing communications made through the at least one broadcast marketing channel on the performance of the non-broadcast marketing communications made through the at least one non-broadcast marketing channel.

28. The apparatus of claim 26, wherein the marketing communications for the offering made through at least one broadcast is part of an integrated marketing campaign and the at least one correlation includes an effect of the performance of the marketing communications made through the broadcast marketing channel on an overall performance of the integrated marketing campaign.

29. An article of manufacture comprising a medium storing instructions that, if executed, enable a processor-based system to:
collect, over a time period, broadcast marketing performance data from at least one provider in at least one venue of at least one broadcast marketing channel used to advertise an offering, wherein the broadcast marketing performance data includes scheduling information for broadcast advertisements of the offering, and wherein the broadcast marketing performance data is collected on a per provider basis in a spreadsheet format;
store the broadcast marketing performance data on a per provider basis in a marketing measurement performance interface in the spreadsheet format;
convert the broadcast marketing performance data from the spreadsheet format to a specialized format of factual data and dimensional data;
store the broadcast marketing performance data in the specialized format in a dimensional database;
collect in near real time web site impact information about the impact of the broadcast advertising on a web site related to the offering, during the time period, using web analytics software, the web site impact information including at least one key metric;
correlate the broadcast marketing performance data, with the near real time web site impact information to create a time-based correlation, wherein the correlation includes a comparison of the scheduling information over an interval in the time period with the key metric over the interval; and
display the correlation.

30. The article of manufacture of claim 29, wherein the broadcast advertisements of the offering are part of an integrated marketing campaign and the correlation comprises a correlation of the effects of the performance of the broadcast advertisements of the offering on an overall performance of the integrated marketing campaign.

31. A system, comprising:
at least one provider computer system of at least one provider configured to assemble marketing performance data regarding marketing communications for an offering, the marketing performance data being assembled in a provider-specific format, and the at least one provider being from at least one marketing venue in at least one broadcast marketing channel;
a marketing performance data interface coupled to the at least one provider computer system and configured to collect, over a time period, the marketing performance data, including broadcast marketing performance data, from the at least one provider computer system, the broadcast marketing performance data collected on a per provider basis in a provider-specific format;
a marketing measurement interface coupled to the marketing performance data interface and configured to transform the broadcast marketing performance data from the provider-specific format to a specialized format of factual data and dimensional data;
a dimensional database coupled to the marketing measurement interface and configured to store the broadcast marketing performance data in the specialized format;
a website for the offering;
a web analytics system coupled to the website for the offering and configured to obtain web site usage data about the impact of the marketing communications on the web site relating to the offering;
a broadcast marketing performance measurement reporting system coupled to the dimensional database and to the web analytics system, the broadcast marketing performance measurement reporting system configured to correlate the broadcast marketing performance data from the dimensional database with the web site usage data to create at least one correlation on at least one level of granularity, and further configured to generate a broadcast marketing performance report including the correlation; and
a display coupled to the broadcast marketing performance measurement reporting system and configured to display the broadcast marketing performance report.
